(19) United States
(12) Patent Application Publication
(10) Pub. No.: US 2024/0384592 A1
(43) Pub. Date: Nov. 21, 2024

(54) RETRACTABLE FABRIC SCREEN SYSTEM WITH SELF-ADJUSTING BOTTOM BAR

(71) Applicant: Alutech United, Inc., Selbyville, DE (US)

(72) Inventor: Aaron Woods, Selbyville, DE (US)

(73) Assignee: Alutech United, Inc., Selbyville, DE (US)

(21) Appl. No.: 18/319,621

(22) Filed: May 18, 2023

(51) Int. Cl. E06B 9/58; E06B 9/54

(52) U.S. Cl. CPC E06B 9/58; E06B 9/54

(57) ABSTRACT

A retractable fabric screen system includes a screen material; a retention pin extending from the screen material; a bottom bar adjustably coupled to an end of the screen material; and an angle bracket fastened to an end of the bar. The screen material retracts or extends in a first direction. The retention pin extends in a second direction next to the screen corner. The bottom bar has a bar body with a length extending along a third direction. The angle bracket has an elongated hole that extends along the first direction. The retention pin slides within the elongated hole. The screen system maintains equal tension at the corners of the fabric as well as along the width of the retractable screen.

### BACKGROUND OF THE INVENTION

The present invention relates to retractable fabric screen systems and, more particularly, to a retractable fabric screen system with a self-adjusting bottom bar.

The corner of the screen on retractable fabric screen systems comes under enormous stress during retraction and causes damage to the fabric. The stress is caused in the bottom corner near the top of the bottom hembar and is due to tension caused by a side retention system rolling larger on the end of the roller tube compared to the fabric body around the roller tube. The roller tube contains a motor that retracts and lowers the screen. The prior art bottom bar doesn't allow for equal tension in the corner of the screen fabric. The bottom bar aids in deployment with the help of gravity and contributes to the aesthetics of the system. But the corners of any large retractable screen with side retention will get extra pulling, causing wrinkles.

As can be seen, there is a need for a retractable fabric screen system with equalized tension across the bottom bar.

### SUMMARY OF THE INVENTION

In one aspect of the present invention, a retractable fabric screen system comprises a screen material configured to retract or extend in a first direction having an end with a corner; a retention pin extending from the screen material in a second direction adjacent the corner; a bottom bar adjustably coupled to the end of the screen material, the bottom bar having a bar body with a length extending along a third direction, the bar body having a bar end; and an angle bracket fastened to the bar end, wherein the angle bracket defines an elongated aperture that extends along the first direction and slidably accommodates the retention pin.

The adjustability of the bottom bar and the retention pin riding within the elongated aperture maintains equal tension at the corners of the fabric as well as the rest of the fabric on the horizontal plane in the retractable screen. The equalized tension improves the life span of the fabric, improves the retraction movement, and improves the overall appearance of the screen system.

These and other features, aspects and advantages of the present invention will become better understood with reference to the following drawings, description, and claims.

### BRIEF DESCRIPTION OF THE DRAWINGS

FIG. 1 is a perspective view of a lower corner of a retractable screen self-adjusting device according to an embodiment of the present invention;

FIG. 2 is an exploded view thereof;

FIG. 3 is a sectional view thereof, taken along 3-3 in FIG. 1; and

FIG. 4 is another sectional view thereof, showing the self-adjusting bottom bar in motion.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a retractable screen with a self-adjusting bottom-end slat that retains equal tension on the corners of the fabric as well as horizontally across the bottom of the fabric. The fabric corner tension glider system allows it to adjust up or down in line with the bottom bar while keeping tension equal across the horizontal tension weld and pocket area of the fabric.

To make the system, the manufacturer may punch a hole in the screen fabric and place a retention pin into the punched hole or adhere it thereto. The manufacturer may assemble retention gliders over the retention pin and mount them to the bottom bar of the retractable screen.

A retractable screening system with an adjustable bottom bar according to an embodiment of the present invention may be operated in the same manner as a prior art retractable screen.

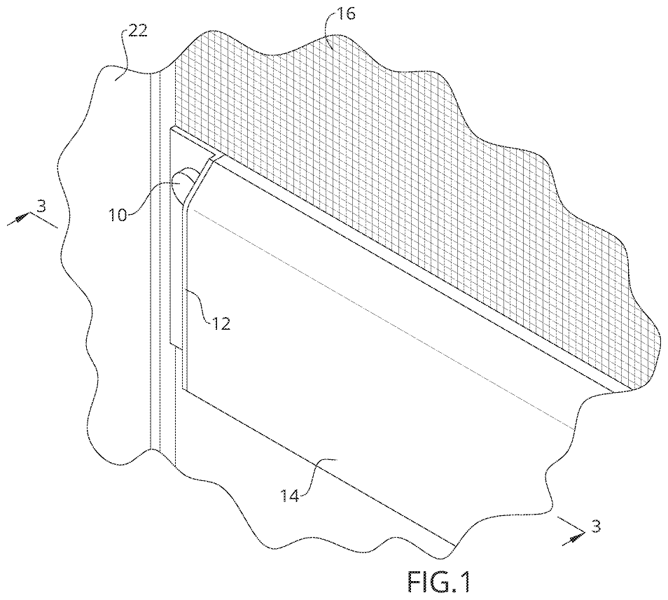

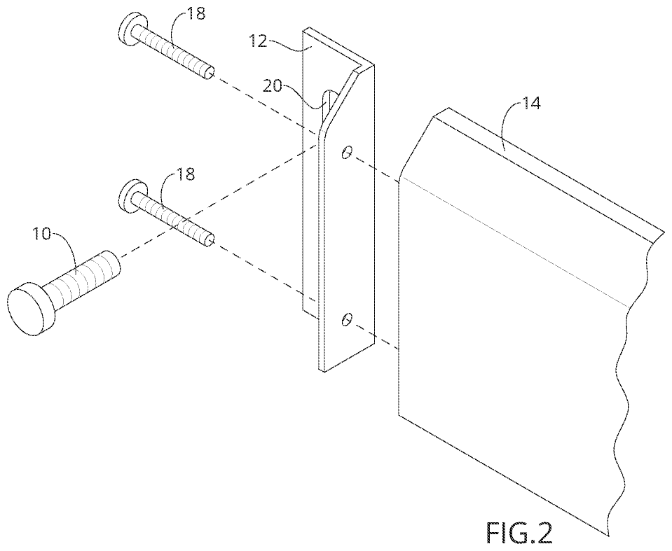

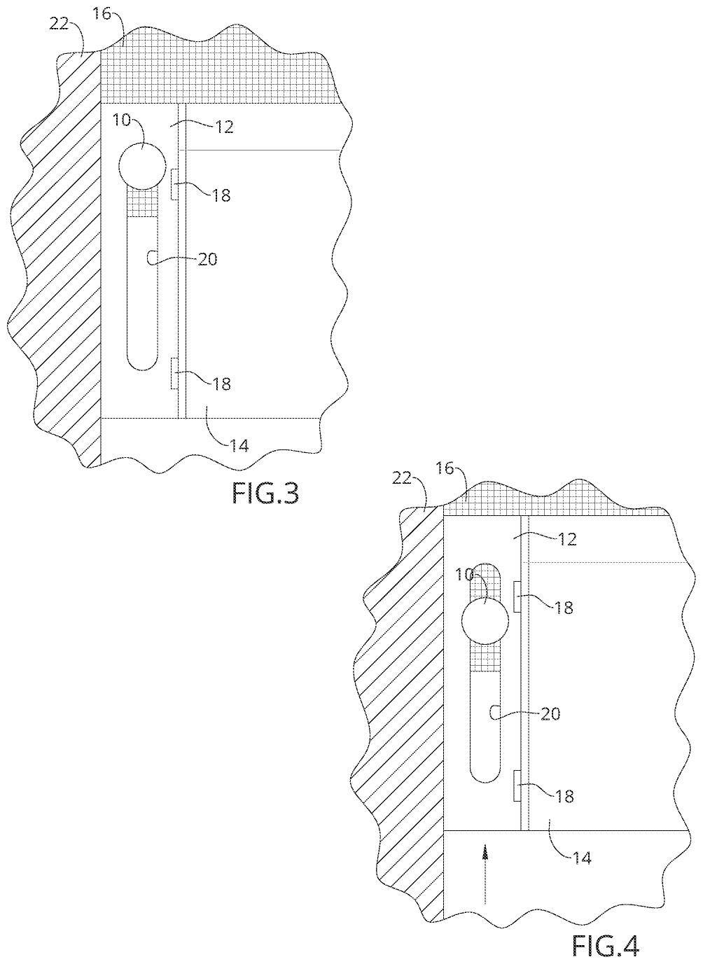

Referring to FIGS. 1 through 4, a retractable fabric screen according to an embodiment of the present invention is movably installed in a screen track 22 longitudinally extending vertically between a stored position and multiple deployed positions. A retention pin 10 extends through the screen fabric 16. The screen has a self-adjusting bottom bar 14 positioned horizontally along a bottom edge of the screen fabric 16. A retention pin gliding bracket 12 is mounted to a side surface of the self-adjusting bottom bar 14 and fastened thereto with fastening hardware 18, such as stainless-steel screws. The gliding bracket 12 has a vertical hole 20 with an oblong perimeter formed therein that slidably accommodates the retention pin 10. When the fabric retention pin glides up or down in the retention pin gliding bracket 12 as shown in FIG. 4, it equalizes tension horizontally across the screen fabric, including at the corner. The directions the screen fabric 16 moves, the retention pin 10 extends, and the length of the bottom bar 14 extends are perpendicular to one another.

It should be understood, of course, that the foregoing relates to exemplary embodiments of the invention and that modifications may be made without departing from the spirit and scope of the invention as set forth in the following claims.

What is claimed is:

1. A retractable fabric screen system, comprising:
a screen material configured to retract or extend in a first direction having an end with a corner;
a retention pin extending from the screen material in a second direction adjacent the corner;
a bottom bar adjustably coupled to the end of the screen material, the bottom bar having a bar body with a length extending along a third direction, the bar body having a bar end; and
an angle bracket fastened to the bar end, wherein the angle bracket defines an elongated aperture therein that extends along the first direction and slidably accommodates the retention pin.

2. The retractable fabric screen system of claim 1, further comprising a screen track extending longitudinally in the first direction; said screen material movable along the screen track between a stored position and a plurality of deployed positions.

3. The retractable fabric screen system of claim 1, further comprising fastening hardware fastening the angle bracket to the bar end.

4. The retractable fabric screen system of claim 1, wherein the elongated aperture is defined by an oblong perimeter.

5. The retractable fabric screen system of claim 1, wherein the second direction is perpendicular to the first direction.

6. The retractable fabric screen system of claim 1, wherein the third direction is perpendicular to the second direction.

7. The retractable fabric screen system of claim 1, wherein the third direction is perpendicular to the first direction.
